(19) United States
(12) Patent Application Publication
(10) Pub. No.: US 2008/0075237 A1
(43) Pub. Date: Mar. 27, 2008

(54) SPEECH RECOGNITION BASED DATA RECOVERY SYSTEM FOR USE WITH A TELEPHONIC DEVICE

(75) Inventors: Assaf Landschaft, Muenchen (DE); Shajith Thengummootil, N.R. Layout (IN)

Correspondence Address: HITT GAINES, PC;LSI Corporation, PO BOX 832570, RICHARDSON, TX, 75083, US

(73) Assignee: Agere Systems, Inc., Allentown, PA (US)

(21) Appl. No.: 11/530,507

(22) Filed: Sep. 11, 2006

(51) Int. Cl. H04M 1/64

(52) U.S. Cl. 379/88.01

(57) ABSTRACT

A data recovery system for a telephonic device based on the formulation of a search query from a word or words recognized during a telephone conversation and the retrieval of a data item based on such search query. In one embodiment, the data recovery system includes (1) a speech recognition subsystem for recognizing at least one spoken word and formulating a search query while the telephonic device is in use; and (2) a search subsystem for using the search query to search available data and create a hyperlink to a data item.

### TECHNICAL FIELD OF THE INVENTION

The present invention is directed, in general, to speech recognition and, more particularly, to a data recovery system based on a data query constructed from words recognized during a telephone conversation.

### BACKGROUND OF THE INVENTION

The versatility of handheld telecommunications devices has made more and better data storage and recovery tools available to users of such devices. Many handheld telecommunications devices currently on the market not only provide traditional telephonic services between two or more parties, but also include several features formerly found only in computers. One such feature is that of being able to store, recover and display to the user a considerable amount of data. Such devices have become telephonic handheld computers where data can be created, filed and stored for use at a later date. The present invention is directed to the efficient recovery of such data.

Presently a user of a prior art telephonic device with computer type data storage capability, who wants to recover data during the course of a telephone conversation must do so by manually searching the device for the data. Of course, this will generally constitute a distraction to the user trying to concentrate on an ongoing conversation while at the same time manually constructing a search query relevant to the conversation.

For example, a salesperson who has data relevant to a potential sale on his or her handheld communications device, who gets a call from a potential customer, will have to manually search for and recall that data while carrying on a conversation with the customer. Because the records on his or her handheld communications device may include information such as that particular customer's requirements, past orders, product specifications, product prices and so on, all of which may be pertinent to a particular sale it is important for the salesperson to be able to quickly and efficiently access such information. At the present time many salespeople are limited to saying they will get back to the customer and going offline to recover the data. What the salesperson really wants is to be able to access the information while the telephone conversation is still taking place. He or she does not want to interrupt the conversation in order to recover the data because he or she may lose the sale.

In other cases, the relevant data may not be on the handheld communications device, but will be available in another data storage device, such as a computer or server that is accessible over the same network with which the handheld device is connected. In such a case the salesperson described above will want to be able to continue his or her conversation with the potential customer while being able to simultaneously access the other data storage devices.

Accordingly, what is needed in the art is a device or system that will automatically search for and display links to relevant data based on the words spoken during an ongoing telephone conversation.

### SUMMARY OF THE INVENTION

To address the above-discussed deficiencies of the prior art, the present invention provides, in one aspect, a data recovery system for a telephonic device, that, in one embodiment, provides for (1) a speech recognition subsystem for recognizing at least one spoken word and formulating a search query while the telephonic device is in use; and (2) a search subsystem for using the search query to search available data and create a hyperlink to a data item.

The present invention thus provides a resource to a user of a telephonic device that permits access to data relevant to a telephone conversation while that conversation is ongoing. For example, if two engineers are discussing a technical problem, the present invention will recognize words spoken while the conversation is in progress; construct a search query based on such words; use the search query to conduct a search of available data; and create a hyperlink to a data item found by such search. This data item could, for example, be found in an email stored in the telephonic device, which email could then be accessed by the user clicking on a hyperlink to such email that is displayed on the telephonic device's screen. During the course of the conversation additional words recognized may be added and the search query revised to perform additional searches and display hyperlinks to other data.

In one embodiment of the invention the telephonic device is a mobile phone. In another embodiment the available data is located within the user's telephonic device. In another embodiment, the available data is not within the telephonic device. For example, as will be understood by those skilled in the pertinent art, the available data may be located in a server remotely located from the telephonic device or in another telephonic device in communication with the user's telephonic device. Thus, an embodiment of the invention provides for available data to be accessed via a network. An embodiment of available data being accessed via a network provides for the network to be the Internet.

A particularly useful embodiment of the invention provides for the recognition of a plurality of spoken words. In yet another embodiment, the speech recognition subsystem formulates the search query by eliminating certain predetermined trivial or common words. Thus, a user or programmer can determine that certain simple or common words, such as “the”, “of”, “and” and so forth should not be included in the search query. This feature speeds up the search function and provides for more efficient usage of the invention.

In another particularly attractive feature of the invention, an embodiment provides for the search query to be revised while the telephonic device is in use. Another embodiment provides for a document to be displayed when a relevant hyperlink is selected by the user. Selection of the hyperlink can be done while the telephonic device is being used to conduct a conversation.

The present invention also provides several embodiments for using the present invention. These embodiments will be clear to those of ordinary skill in the pertinent art based on the present disclosure.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a block diagram of a data recovery system for a telephonic device constructed in accordance with the present invention;

FIG. 2 illustrates a block diagram representing a network that has a telephonic device constructed in accordance with the present invention connected thereto, as well as a mobile phone 210, a standard telephone 220, and a computer; and

FIG. 3 illustrates a flow chart of a method of using one embodiment of the present invention.

### DETAILED DESCRIPTION

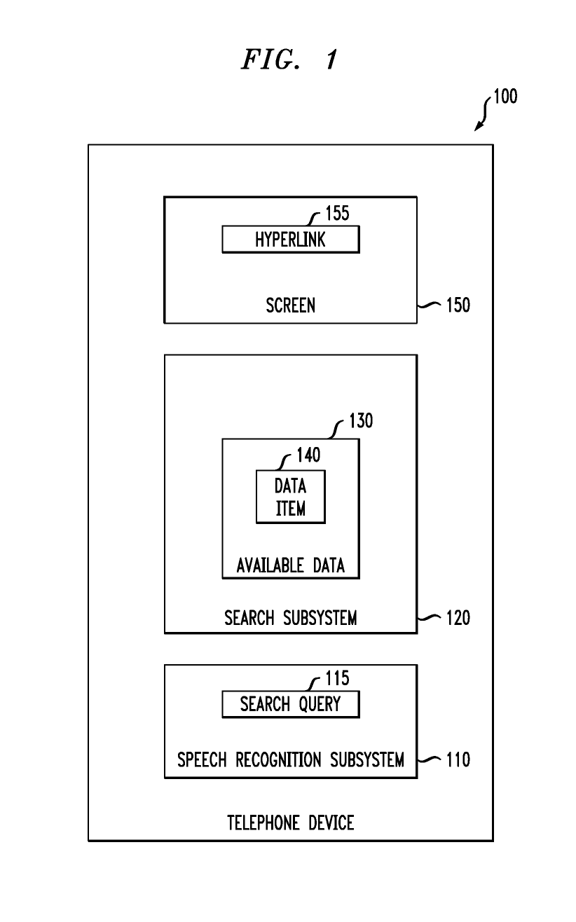

Referring initially to FIG. 1, illustrated is a block diagram of a data recovery system for a telephonic device 100 constructed in accordance with the present invention. As will be readily understood by a person skilled in the relevant art, any type of telephonic device 100 is within the intended scope of the present invention. Thus, the telephonic device 100 can be a desk phone, a computer providing voice communications over the Internet, a cell phone, a Blackberry®, a handheld computer, or any other device providing a telephonic connection between two or more people, all of which are well within the intended scope of the present invention.

The illustrated telephonic device 100 includes a speech recognition subsystem 110 for recognizing at least one spoken word of a user of the device 100. Those skilled in the pertinent art will understand that the speech recognition subsystem 110 can be a software program installed in the memory of the telephonic device 100 or it may be a separate component or subsystem within the telephonic device 100. While the user continues his or her use of the telephonic device 100, the search recognition subsystem 110 formulates a search query 115 based on the recognition of at least one spoken word.

The telephonic device 100 includes a search subsystem 120 that searches for available data 130 based on the search query 115 and displays the results of such search query 115 by creating a hyperlink 155 to a data item 140. The illustrated telephonic device 100 shows available data 130 as data within the telephonic device 100. In the case of a mobile phone with email capability, for example, the data item 140 could be an email stored within the mobile phone's memory. In some mobile communications devices, as noted above, it could be any one of a number of data files that can be stored in current handheld devices. As will be hereinafter illustrated, available data 130 can also include data from any device capable of electronically storing data that can be accessed, directly or indirectly, by the telephonic device 100. The data item 140 can be a document, a drawing, a spreadsheet, or any type of data capable of being stored electronically.

A hyperlink 155 to the data item 140 will then be displayed on a screen 150 of the telephonic device 100, which data item 140 can be displayed by the user clicking on the hyperlink 155. Thus, if the data item 140 is in a document, the entire document will be displayed when the hyperlink 155 is selected by the user. The illustrated embodiment of a telephonic device 100 shows available data 130 within the telephonic device 100 itself. However, another embodiment of the invention provides for available data 130 to reside in a device other than the user's telephonic device 100.

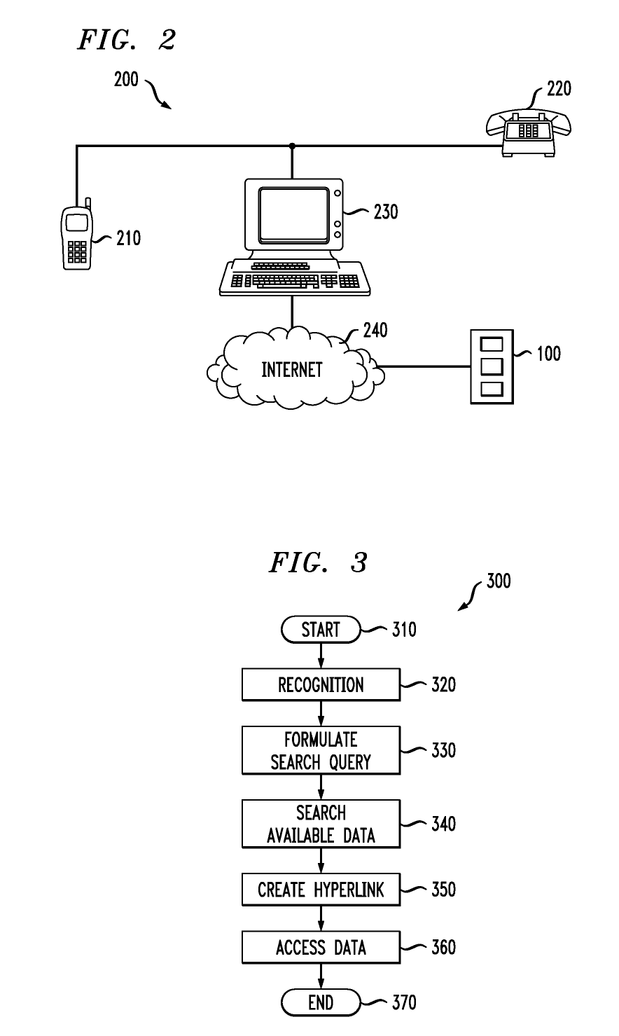

Turning now to FIG. 2, illustrated is a block diagram representing a network 200 that has a telephonic device 100 constructed in accordance with the present invention connected thereto, as well as a mobile phone 210, a standard telephone 220, and a computer 230. As shown, a telephonic connection can be established between a user of the telephonic device 100 and a user of the mobile phone 210 or a user of the standard telephone 220, or both, via the network 200, all of which will also be in communication with the computer 230. The connection can be over a private network 200 or a public network 200, such as a public telephone or cellular company, or the connection could be via the Internet 240, all of which are within the intended scope of the present invention.

FIG. 2 illustrates that available data 130, in one embodiment of the invention, does not have to be within the user's telephonic device 100. The available data 130 can be within any device in communication with the user's telephonic device 100, provided the search subsystem 120 in the user's telephonic device 100 can access the other device and search for data stored therein. For example, available data 130 with respect to a mobile phone 210 can include data in the computer 230 or in a standard telephone 220 in addition to data within the mobile phone 210.

In another embodiment of the invention, the speech recognition subsystem 110 recognizes a plurality of words and formulates a search query 115 based on such plurality. Because most telephone conversations will include a number of words of little or no value in constructing the search query 115, one embodiment of the invention provides for the identification of words deemed insignificant or trivial by eliminating certain predetermined words from the search query. This feature of the invention can be a separate subsystem or it can be included as a feature included in either the search subsystem or the speech recognition subsystem. It is readily apparent that this embodiment will reduce the number of words a system must parse through in order to identify the important words to be included in a search query 115 that will most likely produce a useful result. For example, this embodiment could be structured so that words such as “the”, “and”, “of”, “is” and so on are not included in the search query 115. In many cases the words to be excluded will share the common characteristic of being both short and common. The system could also be structured to permit a user to program the system so that any words he or she considers to be trivial are not considered in the formulation of a search query 115. Those words included in the search query 115 and not screened out as common or trivial, or both, will be considered non-trivial and included in the search query 115.

Another useful embodiment of the invention provides for words to be added to the search query 115 during the course of a conversation. Thus, as the conversation progresses, the search query 115 will be continually modified; the search subsystem 120 will continue to perform new searches; and hyperlinks 155 to data items 140 will be continuously updated. The updated search query 115 may relate to the original subject matter of the telephone conversation or it may relate to an entirely new topic that produces hyperlinks 155 unrelated to the original topic. Thus, as will be readily understood by those of ordinary skill in the pertinent art, the process of identifying words; formulating a search query 115; conducting a search of available data 130; and displaying a hyperlink 140 to data items 1140 will be an ongoing process during the entire course of a user's telephone conversation.

The utility of the present invention is illustrated by considering a telephone conversation between two or more engineers discussing ongoing technical problems with respect to one or more projects. As words are recognized during the course of the conversation, search queries are constructed, databases are searched; and hyperlinks to pertinent documents are displayed. The user can click on a hyperlink to a pertinent document and display the document as the conversation is taking place. If the conversation switches to another topic or project, spoken words relevant to such other topic or project will be recognized, new searches will be made, and different hyperlinks will be displayed. The user can access the new data by clicking on the appropriate hyperlink to recall relevant data.

Turning now to FIG. 3, illustrated is a flow chart of a method 300 of using one embodiment of the present invention. The method commences with a start step 310. In a recognition step 320, the speech recognition subsystem recognizes at least one spoken word used in a telephone conversation. This spoken word could be a word used by the user of the telephone device or by any other party to the conversation. In one embodiment of the invention the speech recognition subsystem recognizes a plurality of spoken words. In a formulate search query step 330, a search query is formulated based on the recognized word or words. While the telephonic device is still in use, a search subsystem searches for available data based on the search query in a search available data step 340. In a create hyperlink step 350, a hyperlink to the data is created and displayed to the user of the telephonic device. He or she can access the data, in an access data step 360, which data can be accessed during the course of the telephone conversation. The method concludes with an end step 370. The present invention also provides several other embodiments to use the present invention. These other embodiments are abundantly clear to those of ordinary skill in the pertinent art based on the foregoing description of the invention.

Although the present invention has been described in detail, those skilled in the pertinent art should understand that they can make various changes, substitutions and alterations herein without departing from the spirit and scope of the invention in its broadest form.

What is claimed is:

1. A data recovery system for a telephonic device, comprising:
a speech recognition subsystem for recognizing at least one spoken word and formulating a search query while said telephonic device is in use; and
a search subsystem for using said search query to search available data and create a hyperlink to a data item.

2. The data recovery system as recited in claim 1 wherein said telephonic device is a mobile phone.

3. The data recovery system as recited in claim 1 wherein said available data is within said telephonic device.

4. The data recovery system as recited in claim 1 wherein said available data is not within said telephonic device.

5. The data recovery system as recited in claim 4 wherein said available data is accessed via a network.

6. The data recovery system as recited in claim 5 wherein said network is the Internet.

7. The data recovery system as recited in claim 1 further comprising said speech recognition subsystem recognizing a plurality of spoken words.

8. The data recovery system as recited in claim 7 wherein said speech recognition subsystem formulates said search query by eliminating certain predetermined trivial or common words.

9. The data recovery system as recited in claim 1 wherein said search query is revised while said telephonic device is in use.

10. The data recovery system as recited in claim 1 wherein a document is displayed when said hyperlink is selected.

11. A method of using a data recovery system for a telephonic device, comprising:
causing a speech recognition subsystem to recognize at least one spoken word and formulate a search query while said telephonic device is in use; and
causing a search subsystem to use said search query to search available data and create a hyperlink to a data item.

12. The method as recited in claim 11 wherein said telephonic device is a mobile phone.

13. The method as recited in claim 11 wherein said available data is within said telephonic device.

14. The method as recited in claim 11 wherein said available data is not within said telephonic device.

15. The method as recited in claim 14 wherein said available data is accessed via a network.

16. The method as recited in claim 15 wherein said network is the Internet.

17. The method as recited in claim 11 further comprising said speech recognition subsystem recognizing a plurality of spoken words.

18. The method as recited in claim 17 wherein said speech recognition subsystem formulates said search query by eliminating certain predetermined short or common words.

19. The method as recited in claim 18 wherein said search query is revised while said telephonic device is in use.

20. The method as recited in claim 11 wherein a document containing said data is displayed when said hyperlink is selected.
